(19) United States
(12) Patent Application Publication
(10) Pub. No.: US 2006/0082279 A1
(43) Pub. Date: Apr. 20, 2006

(54) Shadow mask

(75) Inventors: Hirofumi Hideshima, Tokyo-To (JP); Yuji Anzai, Tokyo-To (JP)

Correspondence Address: OLIFF & BERRIDGE, PLC, P.O. BOX 19928, ALEXANDRIA, VA, 22320, US

(73) Assignee: DAI NIPPON PRINTING CO., LTD., Tokyo-to (JP)

(21) Appl. No.: 11/246,529

(22) Filed: Oct. 11, 2005

(30) Foreign Application Priority Data
Oct. 14, 2004 (JP) 2004-299642

(51) Int. Cl. H01J 29/80

(52) U.S. Cl. 313/402

(57) ABSTRACT

In a shadow mask 201, a large number of slots 2 are made in a mask body 201a in the horizontal direction X and in the vertical direction Y. Each slot 2 has a roughly rectangular backside opening 21 and a roughly rectangular front-side opening 22 that are made by an etching process, and a through-hole 11 that connects these two openings. Of the multiple slots 2 made in the mask body 201a, those slots that are situated at least in the outer end part of the horizontal axis 3 of the mask body 201a or in the outer end part of the diagonal axis 5 of the mask body 201a have rectangular through-holes 11 with protrudent parts 21a (21b), each protrudent part protruding, in the direction opposite to the vertical axis 4, from at least one of the upper and lower end parts of the long side, situated on the side part from the vertical axis 4, of the rectangle, and extended-space parts 25, each extended-space part extending, in the direction in which the vertical axis 4 extends, from at least one of the two short sides of the rectangle to make the through-hole 11, in its plane view, larger. The extended-space part 25 of each through-hole 11 gradually broadens in the vertical direction, from the starting point of extension 25a situated on the vertical axis 4 side in the mask body 201a toward the end point of extension 25b situated on the peripheral part side in the mask body 201a.

### BACKGROUND OF THE INVENTION

1. Field of the Invention

The present invention relates to a shadow mask for forming roughly rectangular beam spots on a fluorescent screen of a color cathode ray tube.

2. Background Art

A shadow mask 1 is, as shown in FIG. 12, mounted in a color cathode ray tube 101 with its surface facing to a fluorescent screen 102 of the color cathode ray tube 101. In the color cathode ray tube 101, electron beams 105 emitted from electron guns 103, deflected by the magnetic fields produced by a deflection yoke 104, pass through the shadow mask 1 and then accurately strike predetermined points on the fluorescent screen 102.

The details of the shadow mask 1 are as follows. FIG. 8 is a diagrammatic plane view illustrating the positional relationship between the slots made in the shadow mask 1. As shown in this figure, the shadow mask 1 comprises a mask body 1a that is roughly rectangular in shape, and a large number of slots 2 (including slots 2a, 2b, 2c, and 2d) are arranged in this mask body 1a in the horizontal direction X and in the vertical direction Y in the plane view, each slot having a roughly rectangular through-hole that penetrates the mask body 1a in the direction of thickness. In this Specification, a unit structure composed of a through-hole, and a front-side opening and a backside opening that form the through-hole is referred to as a “slot”. Further, in FIG. 8, reference numeral 6 denotes a center (also referred to as a “center point”) that is the intersection of two diagonal axes 5, 5 connecting the opposite corners of the mask body 1a, extending along the mask body 1a plane; reference numeral 3, a horizontal axis passing through the center 6, extending along the mask body 1a plane; and reference numeral 4, a vertical axis passing through the center 6, extending along the mask body 1a plane. Furthermore, in FIG. 8, reference numeral 2a denotes a slot situated in the center 6 of the mask body 1a; reference numeral 2b, slots situated in the outer end part of the vertical axis 4; reference numeral 2c, slots situated in the outer end part of the horizontal axis 3; and reference numeral 2d, slots situated in the outer end part of each diagonal axis 5. FIG. 8 is merely a diagrammatic view, and the slots shown in this figure are dimensionally exaggerated.

When such a shadow mask 1 is placed in the color cathode ray tube 101 shown in FIG. 12 with the surface of the shadow mask 1 facing to the fluorescent screen 102 of the color cathode ray tube 101, the electron beams 105 emitted from the electron guns 103 vertically enter the slot 2a situated in the center of the shadow mask 1 but obliquely enter, at angles E, the slots 2b, 2c, and 2d that are situated in the outer end parts of the respective axes (the horizontal axis 3, the vertical axis 4, and the diagonal axes 5), that is, in the peripheral part of the shadow mask 1. For this reason, in the shadow mask 1, the positions of the front-side opening and the backside opening that form the slot are adjusted according to the position of the slot in the mask body.

FIGS. 9A, 9B, 9C and 9D are diagrammatical plane views showing the shape of the slots 2 (slots 2a, 2b, 2c and 2d) made in the respective parts of the mask body 1a of the shadow mask 1. In these figures, reference numeral 11 denotes through-holes of the slots 2. To make the through-holes 11, the front-side openings 12 and the backside openings 13 that are etched in a thin metal sheet are connected. The backside openings 13 are made on the side on which electron beams 7 are incident, and the front-side openings 12 are made on the side from which the electron beams 7 emerge. The backside openings 13 and the front-side openings 12 are made roughly rectangular in shape, and the front-side openings 12 are made large in area so that they do not obstruct the passage of the electron beams 7.

Since electron beams enter, from the front, the slot 2a situated in the center of the mask body 1a, the through-hole 11 (the backside opening 13) of this slot is made so that it is positioned almost in the center of the front-side opening 12, as shown in FIG. 9A. FIG. 9B shows the slot 2b situated in the outer end part of the vertical axis 4; FIG. 9C, the slot 2c situated in the outer end part of the horizontal axis 3; and FIG. 9D, the slot 2d situated in the outer end part of the diagonal axis 5. Electron beams 7 obliquely enter the slots 2b, 2c, and 2d that are situated in the peripheral part of the mask body 1a. Therefore, in order not to obstruct the passage of the electron beams 7 through the through-hole 11 of each slot, the front-side opening 12 is made so that its position is offset from the position of the through-hole 11 (the backside opening 13) to the peripheral part side in the mask body 1a.

However, even when the offset arrangement as shown in FIG. 9 (such an arrangement that the position of the front-side opening 12 of the slot 2 is offset from the position of the through-hole 11 (the backside opening 13) according to the position of the slot 2 in the mask body 1a) is made, of the slots 2b, 2c and 2d made in the peripheral part of the mask body 1a, especially the slots 2c made in the outer end part of the horizontal axis 3 and the slots 2d made in the outer end part of each diagonal axis 5 have the shortcoming that the electron beams 7 that have obliquely entered the slots 2c and 2d are partially blocked by the sidewalls of the front-side openings 12 of these slots, so that these slot cannot let the electron beams 7 strike the fluorescent screen of the cathode ray tube to form thereon beam spots in the desired rectangular shape.

In order to overcome this problem, shadow masks having such a structure that, of the two long sides of a roughly rectangular through-hole of each slot made in a mask body, the long side situated on the side apart from the center of the mask body has a protrudent part protruding in the direction opposite to the vertical axis of the mask body, from at least one of the upper and lower end parts of this long side, have been proposed in Japanese Laid-Open Patent Publications No. 320738/1989 and No. 6741/1993.

FIGS. 10A and 10B are plane views showing the shape of the slots in the conventional shadow masks described in the above patent documents. FIG. 10A is a plane view showing the shape of the slots 2c made in the right-hand outer end part of the horizontal axis 3 in the plane view (FIG. 8) of the mask body 1a. FIG. 10B is a plane view showing the shape of the slots 2d made in the upper-right outer end part of the diagonal axis 5 extending toward the upper right in the plane view (FIG. 8) of the mask body 1a. The slot 2c shown in FIG. 10A has the following features: the position of the front-side opening 12 is offset from the position of the through-hole 11 (the backside opening 13) to the right-side, that is, to the peripheral part side, and, at the same time, of the two long sides of the through-hole 11, the long side situated on the right side, that is, on the peripheral part side, has protrudent parts 11a protruding toward the peripheral part side from the upper and lower end parts of this long side. On the other hand, the slot 2d shown in FIG. 10B has the following features: the position of the front-side opening 12 is offset from the position of the through-hole 11 (the backside opening 13) to the upper right, that is, to the peripheral part side, and, at the same time, of the two long sides of the through-hole 11, the long side situated on the right side, that is, on the peripheral part side, has a protrudent part 11a protruding toward the peripheral part side from the lower end part of this long side.

Further, FIG. 11A is a view in the direction of the arrow XIA in FIG. 10A, showing the slot 2c viewed from the direction in which electron beams pass through the slot 2c, and FIG. 11B is a sectional view taken along line XIB-XIB in FIG. 11A. As shown in FIGS. 11A and 11B, sidewalls 14 and 15 form the front-side opening 12 of the slot 2c; sidewalls 16 and 17 form the backside opening 13 of the slot 2c; and a hole connecting the front-side opening 12 and the backside opening 13 is made as the through-hole 11. In the through-hole 11 having the protrudent parts 11a, these protrudent parts 11a separate the sidewalls 16, 17 from each other, so that the slot 2c can, without blocking, pass electron beams 7 that have entered this slot at a predetermined angle α, as shown in FIG. 11B.

Incidentally, cathode ray tubes have came to be made flat in recent years, like the flat-type color cathode ray tube shown in FIG. 12. In such a flat-type color cathode ray tube, therefore, the angles θ at which electron beams 7 enter the slots 2 made in the shadow mask 1, especially those slots made in the peripheral part of the shadow mask 1, have come to be significantly great. For example, even if the slots 2 have the protrudent parts 11a, electron beams 8 that enter the slots 2 at angles β, as shown in FIG. 11B, are partially blocked by the sidewalls 17 of the backside openings 13 and the sidewalls 15 of the front-side openings 12 at sites near the protrudent parts 11a. Such a phenomenon occurs because the sidewalls 17 of the backside openings 13 and the sidewalls 15 of the front-side openings 12 are sharply rising at sites near the protrudent parts 11a as compared with the sidewalls (represented by the dotted lines in FIG. 11B) situated almost in the center of the through-holes 11, at sites not near the protrudent parts 11a. The electron beams 8 are partially blocked by the sharply rising sidewalls 15, 17 at sites near the protrudent parts 11a and thus become defective, so that these electron beams cannot strike the fluorescent screen of the cathode ray tube to form thereon roughly rectangular beam spots in the desired size.

### SUMMARY OF THE INVENTION

The present invention was accomplished in the light of the aforementioned problems in the prior art. An object of the present invention is therefore to provide a shadow mask having a slot structure that can let electron beams strike a fluorescent screen of a cathode ray tube to form thereon beam spots in the desired size and shape, while preventing, as much as possible, the electron beams from becoming defective even when they enter the slots at increased angles.

The present invention provides, as a first means of fulfilling the above-described object of the invention, a shadow mask that comprises a mask body in which a large number of slots are made in the horizontal and vertical directions and that allows electron beams to form roughly rectangular beam spots on a fluorescent screen of a cathode ray tube, each one of the slots made in the mask body having a roughly rectangular backside opening on the side on which electron beams are incident, a roughly rectangular front-side opening on the side from which electron beams emerge, and a through-hole that connects the backside opening and the front-side opening with each other, the mask body having a center point situated in the center of the mask body plane, and a horizontal axis, a vertical axis, and two diagonal axes that pass through the center point and extend along the mask body plane, the front-side opening and the backside opening of each slot in the mask body being made by an etching process, those slots, of the multiple slots made in the mask body, that are situated at least in the outer end part of the horizontal axis of the mask body or in the outer end part of the diagonal axis of the mask body having rectangular through-holes with extended-space parts, each extended-space part extending, in the direction in which the vertical axis extends, from at least one of the two short sides of the rectangle, that is, at least the short side situated on the side apart from the horizontal axis or the short side situated on the side near the horizontal axis, to make the through-hole, in its plane view, larger, and the extended-space part gradually broadening in the vertical direction, from the starting point of extension situated on the vertical axis side in the mask body toward the end point of extension situated on the peripheral part side in the mask body.

In the above-described first means of fulfilling the object of the invention, it is preferable that each rectangular through-hole situated in the outer end part of the horizontal axis of the mask body has, as the through-hole extended-space part, a pair of extended-space parts extending, in the direction in which the vertical axis extends, from the two short sides of the rectangle to make the through-hole, in its plane view, larger.

Further, in the above-described first means, it is preferable that each rectangular through-hole situated in the outer end part of the diagonal axis of the mask body has, as the through-hole extended-space part, an extended-space part extending, in the direction in which the vertical axis extends, from the horizontal-axis-side short side of the rectangle to make the through-hole, in its plane view, larger.

Furthermore, in the above-described first means, it is preferable that in the extended-space part of each through-hole, the amount of extension that is the distance between the starting point of extension and the end point of extension (the distance in the direction in which the vertical axis extends) be at least 10 μm.

Furthermore, in the above-described first means, it is preferable that the degree to which the extended-space part of the through-hole of each one of the multiple slots made in the mask body is broadened be made higher either continuously or step-wise as the position of the slot gets apart from the center to the peripheral part of the mask body.

Furthermore, in the above-described first means, it is preferable that the rectangular through-hole of each slot further has a protrudent part protruding from at least one of the upper and lower end parts of the long side, situated on the side apart from the vertical axis, of the rectangle toward the peripheral part side, and that this protrudent part and the above-described extended-space part be connected with each other.

Furthermore, in the above-described first means, it is preferable that between each two slots that are arranged adjacently to each other in the direction in which the vertical axis extends be present a bridge portion remaining after the etching step, that, of the multiple slots made in the mask body, those slots situated at least in the outer end part of the horizontal axis of the mask body or in the outer end part of the diagonal axis of the mask body have rectangular front-side openings with extended parts, each extended part extending, in the direction in which the vertical axis extends, from at least one of the two short sides of the rectangle toward the adjacent bridge portion to make the front-side opening, in its plane view, larger, and that the extended part of each front-side opening gradually broadening in the vertical direction, from the starting point of extension that is situated on the vertical axis side in the mask body toward the end point of extension that is situated on the peripheral part side in the mask body. In this case, it is preferable that each rectangular front-side opening situated in the outer end part of the horizontal axis of the mask body has, as the front-side opening extended part, a pair of extended parts extending, in the direction in which the vertical axis extends, from the two short sides of the rectangle toward the respective adjacent bridge portions to make the front-side opening, in its plane view, larger. Further, it is preferable that each rectangular front-side opening situated in the outer end part of the diagonal axis of the mask body has, as the front-side opening extended part, an extended part extending, in the direction in which the vertical axis extends, from the short side, situated on the side apart from the horizontal axis, of the rectangle toward the adjacent bridge portion to make the front-side opening, in its plane view, larger. Furthermore, it is preferable that in the extended part of each front-side opening, the amount of extension that is the distance between the starting point of extension and the end point of extension (the distance in the direction in which the vertical axis extends) be at least 10 μm. Furthermore, it is preferable that the degree to which the extended part of the front-side opening of each one of the multiple slots made in the mask body is broadened be made higher either continuously or step-wise as the position of the slot gets apart from the center to the peripheral part of the mask body.

The present invention provides, as a second means of fulfilling the above-described object of the invention, a shadow mask that comprises a mask body in which a large number of slots are made in the horizontal and vertical directions and that allows electron beams to form roughly rectangular beam spots on a fluorescent screen of a cathode ray tube, each one of the slots made in the mask body having a roughly rectangular backside opening on the side on which electron beams are incident, a roughly rectangular front-side opening on the side from which electron beams emerge, and a through-hole that connects the backside opening and the front-side opening with each other, the mask body having a center point situated in the center of the mask body plane, and a horizontal axis, a vertical axis, and two diagonal axes that pass through the center point and extend along the mask body plane, the front-side opening and the backside opening of each slot in the mask body being made by an etching process, and between each two adjacent slots arranged in the direction in which the vertical axis extends being present a bridge portion remaining after the etching step, those slots, of the multiple slots made in the mask body, that are situated at least in the outer end part of the horizontal axis of the mask body or in the outer end part of the diagonal axis of the mask body having rectangular front-side openings with extended parts, each extended part extending, in the direction in which the vertical axis extends, from at least one of the two short sides of the rectangle to make the front-side opening, in its plane view, larger, and the extended part of each front-side opening gradually broadening in the vertical direction, from the starting point of extension situated on the vertical axis side in the mask body toward the end point of extension situated on the peripheral part side in the mask body.

In the above-described second means of fulfilling the object of the present invention, it is preferable that each rectangular front-side opening situated in the outer end part of the horizontal axis of the mask body has, as the front-side opening extended part, a pair of extended parts extending, in the direction in which the vertical axis extends, from the two short sides of the rectangle toward the respective adjacent bridge portions to make the front-side opening, in its plane view, larger.

Further, in the above-described second means, it is preferable that each rectangular front-side opening situated in the outer end part of the diagonal axis of the mask body has, as the front-side opening extended part, an extended part extending, in the direction in which the vertical axis extends, from the short side, situated on the side apart from the horizontal axis, of the rectangle toward the adjacent bridge portion to make the front-side opening, in its plane view, larger.

Furthermore, in the above-described second means, it is preferable that in the extended part of each front-side opening, the amount of extension that is the distance between the starting point of extension and the end point of extension (the distance in the direction in which the vertical axis extends) be at least 10 μm.

Furthermore, in the above-described second means, it is preferable that the degree to which the extended part of the front-side opening of each one of the multiple slots made in the mask body is broadened be made higher either continuously or step-wise as the position of the slot gets apart from the center to the peripheral part of the mask body.

According to the shadow mask of the present invention, of the multiple slots made in the mask body, those slots that are situated at least in the outer end part of the horizontal axis of the mask body or in the outer end part of the diagonal axis of the mask body have rectangular through-holes with extended-space parts, each extended-space part extending, in the direction in which the vertical axis extends, from at least one of the short two sides of the rectangle to make the through-hole, in its plane view, larger, and this extended-space part of each through-hole gradually broadens in the vertical direction, from the starting point of extension that is situated on the vertical axis side in the mask body toward the end point of extension that is situated on the peripheral part side in the mask body, so that it is possible to make the sidewalls of the backside openings and those of the front-side openings recede at sites near the protrudent parts, thereby making the sidewalls rise less sharply. It is, therefore, possible to eliminate, as much as possible, the problem in the prior art that electron beams are partially blocked by the rising sidewalls at sites near the protrudent parts and become defective. Consequently, a shadow mask having such a slot structure can prevent, as much as possible, electron beams that have passed through the through-holes of the slots from being blocked by the front-side openings even when the angles at which the electron beams enter the shadow mask are made greater and can let the electron beams strike a fluorescent screen of a cathode ray tube to form thereon beam spots in the desired size and shape, while keeping the luminance high.

Further, according to the shadow mask of the present invention, when the through-hole of each slot situated in the outer end part of the horizontal axis is made to have extended-space parts extending in the vertical direction toward the upper and lower bride portions, and when the through-hole of each slot situated in the outer end part of the diagonal axis is made to have an extended-space part extending toward the bridge portion present on the horizontal axis side, the shadow mask finally obtained can be properly applied to flat-type cathode ray tubes of wide deflection angle type, which are in great demand in recent years.

Furthermore, according to the shadow mask of the present invention, when, of the multiple slots made in the mask body, those slots that are situated at least in the outer end part of the horizontal axis of the mask body or in the outer end part of the diagonal axis of the mask body are made to have rectangular front-side openings with extended parts, each extended part extending, in the direction in which the vertical axis extends, from at least one of the two short sides of the rectangle toward the adjacent bridge portion to make the front-side opening, in its plane view, larger, and when the extended part of each front-side opening is made gradually broaden in the vertical direction, from the starting point of expansion that is situated on the vertical axis side in the mask body toward the end point of expansion that is situated on the peripheral part side in the mask body, it is possible to make the sidewalls of the front-side openings recede to make the inclination of the sidewalls much smaller. It is, therefore, possible to eliminate, as much as possible, the problem in the prior art that electron beams are partially blocked by the sidewalls at sites near the bridge portions and become defective. Consequently, there can be obtained the same actions and effects as those ones that are described above.

Furthermore, according to the shadow mask of the present invention, it is possible to prevent the blocking of electron beams, with certainty, by setting the amount of extension (the distance, in the vertical direction, between the starting point of extension and the end point of extension) of the extended-space part of the through-hole of each slot or of the extended part of the front-side opening of each slot to at least 10 μm.

### BRIEF DESCRIPTION OF THE DRAWINGS

In the drawings,

FIG. 1A is a plane view showing a shadow mask according to an embodiment of the present invention,

FIG. 1B is an enlarged plane view showing an example of the shape of a slot made in the outer end part of the horizontal axis of the shadow mask shown in FIG. 1A,

FIG. 2 is an enlarged plane view showing an example of the shape of a slot made in the outer end part of the diagonal axis of the shadow mask shown in FIG. 1A,

FIG. 3 is a sectional view of the slot shown in FIG. 1B, taken along line III-III in FIG. 1B,

FIG. 4 is an enlarged plane view showing another example of the shape of a slot made in the outer end part of the horizontal axis of the shadow mask shown in FIG. 1A,

FIG. 5 is an enlarged plane view showing another example of the shape of a slot made in the outer end part of the diagonal axis of the shadow mask shown in FIG. 1A,

FIG. 6 is a sectional view of the slot shown in FIG. 5, taken along line VI-VI in FIG. 5,

FIGS. 7A, 7B, 7C and 7D are enlarged plane views showing further examples of the shape of slots made in the shadow mask shown in FIG. 1A,

FIG. 8 is a diagrammatical plane view illustrating the positional relationship between the slots made in various parts of a shadow mask,

FIGS. 9A, 9B, 9C and 9D are diagrammatical plane views showing the shape of slots made in various parts of a shadow mask,

FIGS. 10A and 10B are plane views showing the shape of slots made in a conventional shadow mask,

FIG. 11A is a view in the direction of the arrow XIA in FIG. 10A, showing the slot shown in FIG. 10A, viewed from the direction in which electron beams pass through this slot,

FIG. 11B is a sectional view taken along line XIB-XIB in FIG. 11A, and

FIG. 12 is a sectional view showing the basic structure of a flat-type color cathode ray tube in which a shadow mask is incorporated.

### DETAILED DESCRIPTION OF PREFERRED EMBODIMENTS

Embodiments of the present invention will be described with reference to the accompanying drawings. The present invention is not limited to the following embodiments and encompasses a variety of other embodiments that are within the technical concept of the present invention.

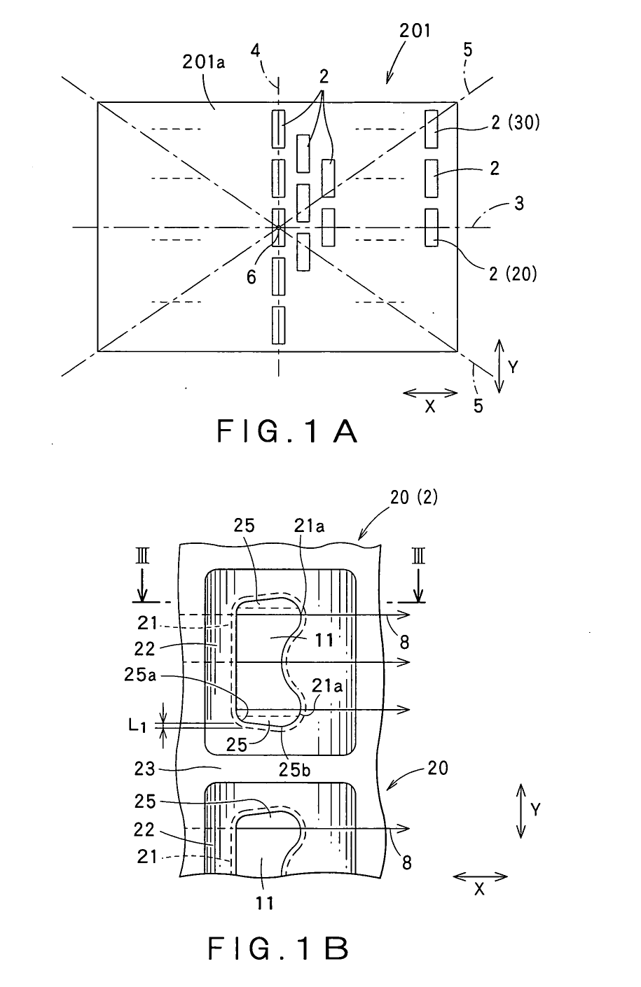

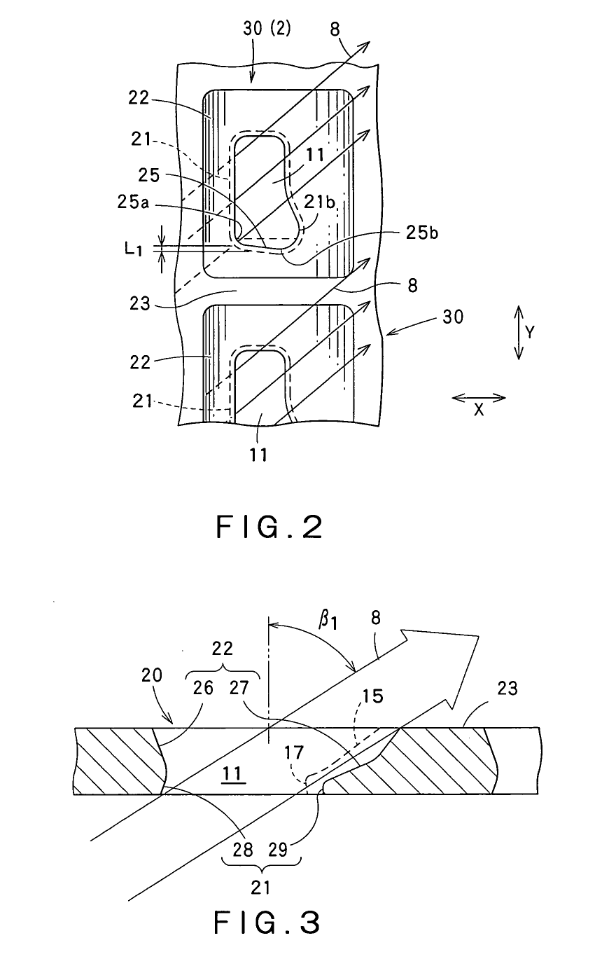

First of all, the entire structure of a shadow mask according to an embodiment of the present invention will be described with reference to FIGS. 1A, 1B and 2.

As shown in FIG. 1A, a shadow mask 201 according to this embodiment comprises a mask body 201a that is roughly rectangular in shape, and this mask body 201a has a large number of slots 2 (including slots 20, 30) with roughly rectangular through-holes penetrating the mask body 201a in the direction of thickness. As shown in FIGS. 1B and 2, each slot 2 has a through-hole 11 that is composed of a front-side opening 22 and a backside opening 21. The through-hole 11 of each slot 2 is made so that it connects the front-side opening 22 and the backside opening 21 that are etched in a thin metal sheet. Further, a large number of the slots 2 are arranged on the mask body 201a plane in the horizontal direction X and in the vertical direction Y, as shown in FIG. 1A. When mounted in a cathode ray tube, such a shadow mask 201 acts not only to shield electromagnetic waves but also to let electron beams strike a fluorescent screen of the cathode ray tube to form thereon roughly rectangular beam spots. In FIG. 1A, reference numeral 6 denotes a center point that is the intersection of two diagonal axes 5, 5 connecting the opposite corners of the mask body 201a, extending along the mask body 201a plane; reference numeral 3, a horizontal axis passing through the center 6, extending along the mask body 201a plane; and reference numeral 4, a vertical axis passing through the center 6, extending along the mask body 201a plane. FIG. 1A is merely a diagrammatic view, and the slots shown in this figure are dimensionally exaggerated.

In the shadow mask 201 according to this embodiment, of the multiple slots 2 made in the mask body 201a, those slots 2 (20, 30) that are situated at least in the outer end part of the horizontal axis 3 of the mask body 201a or in the outer end part of the diagonal axis 5 of the mask body 201a have such through-holes 11 as those ones shown in FIGS. 1B and 2. Namely, each rectangular through-hole 11 has a protrudent part 21a (21b) protruding, in the direction opposite to the vertical axis 4, from at least one of the upper and lower end parts of the long side, situated on the side apart from the vertical axis 4, of the rectangle, and an extended-space part (through-hole extended-space part) 25 extending, in the direction in which the vertical axis 4 extends, from at least one of the two short sides of the rectangle to make the through-hole, in its plane view, larger. The extended-space part 25 gradually broadens in the vertical direction, from the starting point 25a of extension that is situated on the vertical axis 4 side in the mask body 201a toward the end point 25b of extension that is situated on the peripheral part side in the mask body 201a.

The slots 2 (20, 30) having such through-holes 11 have front-side openings 22 and backside openings 21 that are etched in a thin metal sheet, as described above. The backside openings 21 are made on the side on which electron beams are incident, and the front-side openings 22 are made on the side from which electron beams emerge. These backside openings 21 and front-side openings 22 are made roughly rectangular in shape.

The front-side opening 22 that forms the slot 2 is composed of sidewalls 26 and 27, as shown in FIG. 3, and is made to have a large area so that it does not obstruct the passage of electron beams 8. Further, as shown in FIGS. 1B and 2, narrow bridge portions 23 remaining after the etching step are present between the front-side openings 22 of the slots 2 (20, 30) that are arranged adjacently in the vertical direction Y (in the direction in which the vertical axis 4 extends). The shadow mask 201 comprising the mask body 201a that includes the bride portions 23 remaining after the etching step is excellent in mechanical strength. Such a shadow mask is advantageous in that it can be produced with a higher yield because it is scarcely deformed in press molding. Moreover, since the shadow mask shows good durability when it is dropped, it is advantageous also in that it is highly reliable in quality.

The slot 20 shown in FIG. 1B and the slot 30 shown in FIG. 2 will be described hereinafter in detail.

The slot 20 shown in FIG. 1B is a slot that is made in the right-hand outer end part of the horizontal axis 3 of the mask body 201a, as shown in the plane view of the mask body 201a (FIG. 1A). This slot 20 includes the slot 20 shown in FIG. 1A and slots arranged adjacently to the slot 20 in the horizontal direction X. In the slot 20, the position of the front-side opening 22 is offset from the position of the through-hole 11 (the backside opening 21) to the right-hand outer end of the horizontal axis 3, that is, to the peripheral part side. The long side, situated on the peripheral part side, of the through-hole 11 has protrudent parts 21a protruding toward the outer end of the horizontal axis 3. These protrudent parts 21a are made so that they protrude from both end parts (the upper and lower end parts) of this long side extending in the vertical direction Y, and increase the area of incidence of electron beams 8 that enter the through-hole 11 obliquely from below.

The slot 30 shown in FIG. 2 is a slot that is made in the upper-right outer end part of the diagonal axis 5 obliquely extending toward the upper right, as shown in the plane view of the mask body 201a (FIG. 1A). This slot 30 includes the slot 30 shown in FIG. 1A and slots arranged adjacently to the slot 30 in the vertical direction Y. In the slot 30, the position of the front-side opening 22 is offset from the position of the through-hole 11 (the backside opening 21) to the outer end of the diagonal axis 5. The long side, situated on the peripheral part side, of the through-hole 11 has a protrudent part 21b protruding toward the peripheral part side. The protrudent part 21b is made so that it protrudes from the lower end part of this long side extending in the vertical direction Y, and increases the area of incidence of electron beams 8 that enter the through-hole 11 obliquely from below.

The front-side openings 22 that form the slots 2 (including the slots 20, 30) vary in position relative to the through-hole 11 (the backside opening 21), depending on the position of the slot in the mask body 201a. Namely, as shown in FIG. 1A, in the slot 2 situated in the center 6 of the mask body 201a, the front-side opening 22 is made so that the through-hole 11 (the backside opening 21) is positioned in its center. On the other hand, those slots 2 situated in the outer end part of the horizontal axis 3 are made in such a manner that the position of the front-side opening 22 is gradually offset from the position of the through-hole 11 (the backside opening 21) to the peripheral part side as the position of the slot 2 gets apart from the center 6. Similarly, those slots 2 situated in the outer end part of the vertical axis 4 are made in such a manner that the position of the front-side opening 22 is gradually offset from the position of the through-hole 11 (the backside opening 21) to the peripheral part side as the position of the slot 2 gets apart from the center 6.

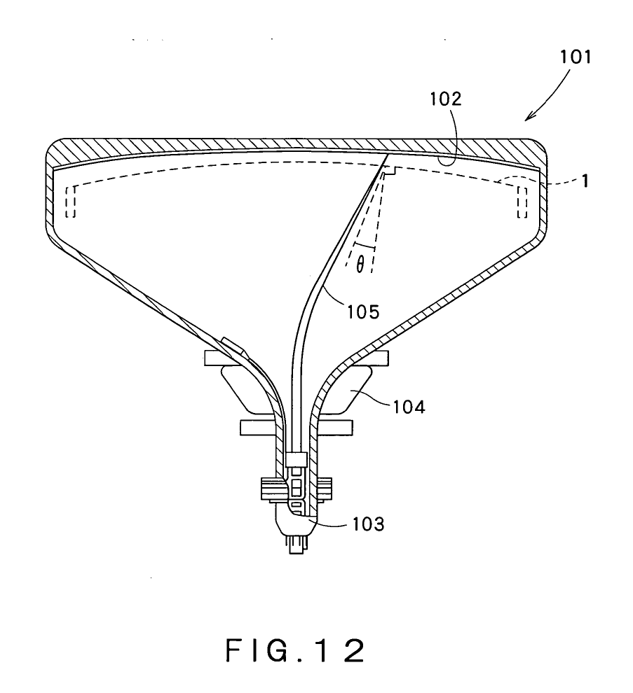

The above description is applicable also to those slots 2 that are situated on or along the diagonal axes 5, 5; that is, these slots 2 are made in such a manner that the position of the front-side opening 22 is gradually offset from the position of the through-hole 11 (the backside opening 21) to the peripheral part side as the position of the slot 2 gets apart from the center 6. For example, in the plane view (FIG. 1A) of the mask body 201a, those slots situated on or along the diagonal axis 5 obliquely extending toward the upper right are made so that the position of the front-side opening 22 is gradually offset from the position of the through-hole 11 (the backside opening 21) to the right-hand side and upward (that is, to the upper right) as the position of the slot 2 gets apart from the center 6 toward the upper right, while that the position of the front-side opening 22 is gradually offset from the position of the through-hole 11 (the backside opening 21) to the left-hand side and downward (that is, to the lower left) as the position of the slot 2 gets apart from the center 6 toward the lower left. The same is true for those slots 2 situated on or along the diagonal axis 5 obliquely extending toward the lower right. The amount of the offset varies according to the angle θ at which electron beams 8 obliquely enter the slots 2 (see FIG. 12), and is determined so that the electron beams 8 that have passed through the through-holes 11 are not partially blocked by the sidewalls (reference numeral 27 in FIG. 3) of the front-side openings 22.

In the shadow mask 201 according to this embodiment, of the multiple slots 2 made in the mask body 201a, those slots 2 (20, 30) that are situated at least in the outer end part of the horizontal axis 3 of the mask body 201a or in the outer end part of the diagonal axis 5 of the mask body 201 have through-holes 11 with extended-space parts 25. Each slot 20 situated in the outer end part of the horizontal axis 3 has extended-space parts 25 extending, in the vertical direction Y, from the through-hole 11 toward the bridge portions 23, 23 that are present on both the upper and lower sides of the through-hole 11. On the other hand, each slot 30 situated in the outer end part of the diagonal axis 5 has an extended-space part 25 extending from the through-hole 11 toward the bridge portion 23 present on the horizontal axis 3 side of the through hole 11.

Since each slot 20 situated in the outer end part of the horizontal axis 3 is made to have the extended-space parts 25 extending, in the vertical direction Y, toward the bridge portions 23, 23 present on the upper and lower sides of the through-hole 11, as shown in FIG. 1B, the protrudent parts 21a and the extended-space parts 25 are connected with each other. On the other hand, each slot 30 situated in the outer end part of the diagonal axis 5 has the extended-space part 25 extending toward the bridge portion 23 situated on the horizontal axis 3 side of the through-hole 11, as shown in FIG. 2, so that the protrudent part 21a and the extended-space part 25 are connected with each other, like in the above case, at a site at which the extended-space part 25 is present.

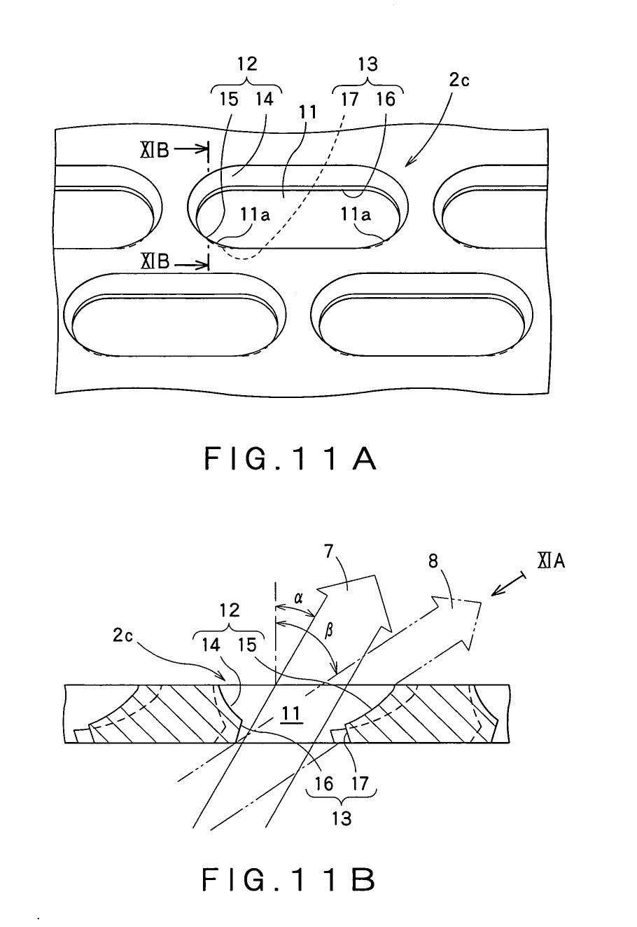

FIG. 3 is a sectional view of the slot 20 having the through-hole 11 with the extended-space parts 25 (a sectional view taken along line III-III in FIG. 1B). In the slot 20 shown in FIG. 1A, the sidewalls 26, 27 form the front-side opening 22, and the sidewalls 28, 29 form the backside opening 21. The through-holes 11 having the extended-space parts 25 are, as will be described later, made by etching the front-side openings 22 and the backside openings 21 in a predetermined pattern. By making the extended-space parts 25 in the etched through-hole 11, it is possible to make the sidewall 27 of the front-side opening 22 and the sidewall 29 of the backside opening 21 recede from the position of the sidewalls shown by the dotted lines (the sidewalls 15, 17 shown in FIG. 11B) toward the bridge portion (the bridge portion between the front-side openings 22 that are situated adjacently to each other in the horizontal direction X), thereby making these sidewalls rise less sharply. By so making the sidewalls, those portions of the through-hole 11 and of the sidewalls 27, 29 that correspond to the extended-space parts 25 recede toward the bridge portion (the bridge portion between the front-side openings 22 that are situated adjacently to each other in the horizontal direction X), and the opening area is increased to such an extent that electron beams are not partially blocked by the rising sidewalls at sites near the protrudent parts to be defective. Consequently, electron beams 8 that cannot pass through through-holes of a conventional embodiment can pass through the through-holes having the extended-space parts 25.

In the slots 2 having such extended-space parts 25, even when electron beams 8 enter the through-holes 11 at a large angle β1, as shown in FIG. 3, the sidewalls 29 that have receded toward the bridge portions 23 minimize the blocking of the electron beams 8. Such slots 2 can, therefore, pass the electron beams 8 so that the electron beams 8 strike a fluorescent screen to form thereon roughly rectangular beam spots in the desired size.

For example, the amount of extension L₁ of the extended-space part 25 made in the through-hole 11 of the slot 2 situated in the outermost end part of the diagonal axis 5, the angle θ (see FIG. 12) at which electron beams 8 enter this part of the shadow mask 201 being greatest, is set to at least 10 μm. The amount of extension L₁ herein means the distance, in the vertical direction, between the starting point 25a of extension and the end point 25b of extension. The reason why the amount of extension L₁ of the extended-space part 25 of the through-hole 11 of the slot 2 situated in the outermost end part of the diagonal axis 5 is set to at least 10 μm is as follows: 10 μm is the minimum value needed to make the sidewall of the backside opening 21 and the sidewall of the front-side opening 22 recede to such an extent that electron beams are not partially blocked by these sidewalls to be defective. The amount of extension L₁ is freely selected from the range of 10 μm or more depending, for example, upon the characteristics of a cathode ray tube in which the shadow mask 201 will be incorporated. In the case of a shadow mask that is preferably used for a flat-type cathode ray tube in which the angle of deflection is 110° or more, the preferred amount of extension L₁ in the slot 2 situated in the outermost end part of the diagonal axis 5 is 20 μm or more and 40 μm or less. This upper limit of the amount of extension L₁, 40 μm, is determined with consideration for the formation of the desired beam spots. In this embodiment, by setting the amount of extension L₁ to a value in the above-described range, it is possible to obtain the aforementioned effects and prevent electron beams 8 from being blocked by the sidewall of the front-side opening 22 of the slot 2, with certainty. It is preferable that the degree to which the extended-space part 25 is broadened be made higher either continuously or step-wise as the position of the slot 2 gets apart from the center 6 to the peripheral part of the mask body 201a, depending upon the angle at which electron beams 8 enter the shadow mask 201.

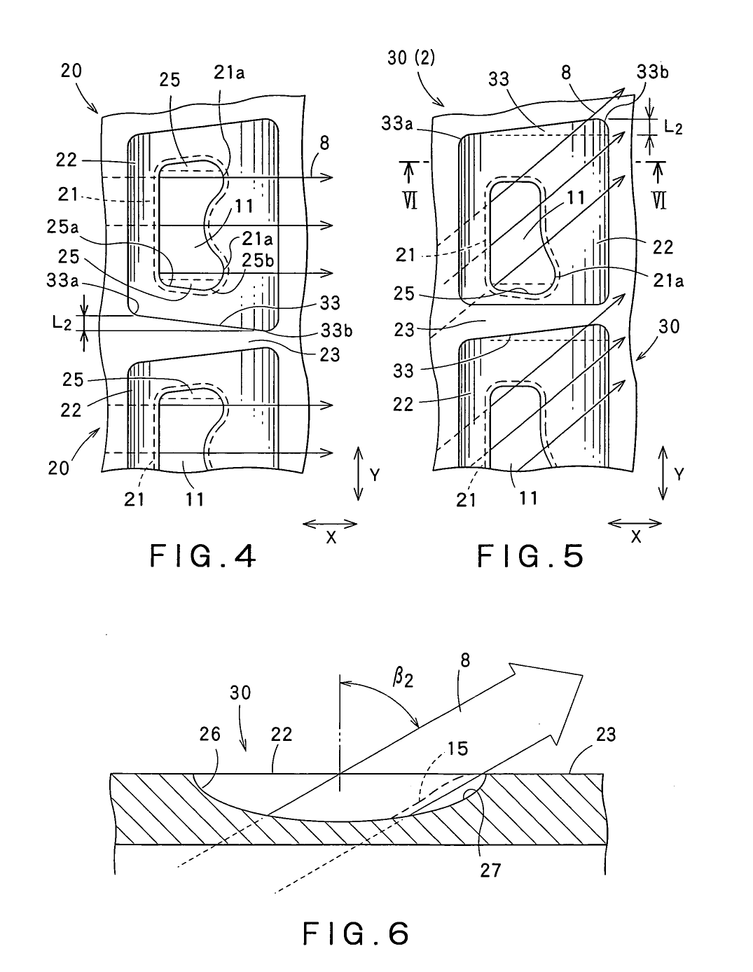

In the slots 2 (20, 30) in the above-described shadow mask 201 shown in FIGS. 1B, 2 and 3, the front-side openings 22 of the slots 2 (20, 30) are rectangular in shape. The present invention is not limited to this, and the front-side openings 22 of the slots 2 (20, 30) situated at least in the outer end part of the horizontal axis 3 of the mask body 201a or in the outer end part of the diagonal axis 5 of the mask body 201a may have extended parts (the front-side opening extended parts) 33, as in the embodiments shown in FIGS. 4 to 6.

Also in the embodiments shown in FIGS. 4 to 6, each through-hole 11 has an extended-space part 25 extending toward the bridge portion 23, as in the slots 20, 30 shown FIGS. 1B, 2 and 3. Further, the position of the front-side opening 22 is similarly offset from the position of the through-hole 11 (the backside opening 21). In addition, in the embodiments shown in FIGS. 4 to 6, each front-side opening 22 has an extended part 33 extending toward the bridge portion 23.

Namely, in the embodiments shown in FIGS. 4 to 6, of the multiple slots 2 made in the mask body 201a, those slots 2 (20, 30) that are situated at least in the outer end part of the horizontal axis 3 of the mask body 201a or in the outer end part of the diagonal axis 5 of the mask body 201a have rectangular front-side openings 22 with extended parts 33, each extended part extending, in the direction in which the vertical axis 4 extends, from at least one of the two short sides of the rectangle toward the adjacent bridge portion 35 to increase the front-side opening, in its plane view, larger. The extended part 33 gradually broadens in the vertical direction, from the starting point 33a of extension situated on the vertical axis 4 side in the mask body 201a toward the end point 33b of extension that is situated on the peripheral part side in the mask body 201a.

The rectangular front-side opening 22 of each slot 20 situated in the outer end part of the horizontal axis 3 has, as shown in FIG. 4, extended parts 33 extending, in the vertical direction Y, from both the upper and lower short sides of the rectangle toward the respective adjacent bridge portions 23. On the other hand, the rectangular front-side opening 22 of each slot 30 situated in the outer end part of the diagonal axis 5 has, as shown in FIG. 5, an extended part 33 extending, in the vertical direction Y, from the upper short side of the rectangle (i.e., the short side situated on the side apart from the horizontal axis 3) toward the bridge portion 23.

By thus making the extended parts 33 in the front-side openings 22 of the slots (20, 30), it is possible to enlarge the opening areas useful for letting the electron beams 8 that have passed through the through-holes 11 easily pass through the slots 2. As mentioned above, since the through-holes 11 have the extended-space parts 25 in this embodiment, enlargement of the opening areas can be achieved by both the extended parts 33 and the extended-space parts 25.

The effects of the extended parts 33 of the front-side openings 22 of the slots 2 (20, 30) will be described with reference to FIG. 6.

As shown in FIG. 6, by making the extended part 33 in the front-side opening 22 of each slot 2 (20), it is possible to make the sidewall 27 of the front-side opening 22 recede from the sidewall shown by the dotted line (the sidewall 15 shown in FIG. 11B) toward the bridge portion (the bridge portion present between the front-side openings 22 that are arranged adjacently to each other in the horizontal direction X), thereby making the inclination of the sidewall much smaller. It is, therefore, possible to eliminate, as much as possible, the problem in the prior art that electron beams are partially blocked by the sidewalls at sites near the bridge portions to be defective.

Thus, since the opening area of each front-side opening 22 is increased by making the extended part 33 in the front-side opening 22 and the opening area of each through-hole 11 is increased by making the extended-space part 25 in the through-hole 11, the permissible range of angles β₂ at which electron beams 8 enter the slots 2 is drastically broadened. Consequently, even when electron beams 8 enter the slots 2 at large angles β₂, the slots 2 can pass the electron beams 8 so that the electron beams 8 strike the fluorescent screen of the cathode ray tube to form thereon roughly rectangular beam spots in the desired size. The shadow mask with such slots 2 can, therefore, be preferably applied to flat-type cathode ray tubes of large deflection angle type.

Also the amount of extension L₂ of the extended part 33 made in the front-side opening 22 of the slot 2 situated in the outermost end part of the diagonal axis 5, the angle θ (see FIG. 12) at which electron beams 8 enter this part of the shadow mask 201 being greatest, is set to at least 10 μm, like the amount of extension L₁ of the extended-space part 25 of the through-hole 11. The amount of extension L₂ herein means the distance, in the vertical direction, between the starting point 33a of extension and the end point 33b of extension. The reason why the amount of extension L₂ of the extended part 33 of the front-side opening 22 of the slot 2 situated in the outermost end part of the diagonal axis 5 is set to at least 10 μm is as follows: 10 μm is the minimum value needed to make the sidewall of the front-side opening 22 recede to such an extent that electron beams are not partially blocked by this sidewall to be defective. The amount of extension L₂ is freely selected from the range of 10 μm or more depending, for example, upon the characteristics of a cathode ray tube in which the shadow mask 201 will be incorporated. In the case of a shadow mask that is preferably used for a flat-type cathode ray tube in which the angle of deflection is 110° or more, the preferred amount of extension L₂ of the extended part 33 of the front-side opening 22 of the slot 2 situated in the outermost end part of the diagonal axis 5 is 15 μm or more and 25 μm or less. This upper limit of the amount of extension L₂, 25 μm, is determined with consideration for mask strength and press molding properties. In this embodiment, by setting the amount of extension L₂ to a value in the above-described range, it is possible to obtain the aforementioned effects and prevent electron beams 8 from being blocked by the sidewall of the front-side opening 22 of the slot 2, with certainty. It is preferable that the degree to which the extended part 33 is broadened be made higher either continuously or step-wise as the position of the slot 2 gets apart from the center 6 to the peripheral part of the mask body 201a, depending upon the angle at which electron beams 8 enter the shadow mask 201.

According to the shadow mask 201 of this embodiment, of the multiple slots 2 made in the mask body 201a, those slots 2 (20, 30) situated at least in the outer end part of the horizontal axis 3 of the mask body 201a or in the outer end part of the diagonal axis 5 of the mask body 201a have rectangular through-holes 11 with extended-space parts 25, each extended-space part extending, in the direction in which the vertical axis 4 extends, from at least one of the upper and lower short sides of the rectangle, that is, at least the short side situated on the side apart from the horizontal axis 3 or the short side situated on the side near the horizontal axis 3, to make the through-hole 11, in its plane view, larger, and this extended-space part 25 gradually broadens in the vertical direction, from the starting point 25a of extension that is situated on the vertical axis 4 side in the mask body 201a toward the end point 25b of extension that is situated on the peripheral part side in the mask body 201a. For this reason, the sidewalls of the backside openings 21 and those of the front-side openings 22 recede at sites near the protrudent parts 21a (21b) to rise less sharply. It is, therefore, possible to eliminate, as much as possible, the problem in the prior art that electron beams are partially blocked by the rising sidewalls at sites near the protrudent parts 21a (21b) to be defective. Consequently, the shadow mask 201 having such a slot structure can prevent, as much as possible, the electron beams 8 that have passed through the through-holes 11 of the slots 2 (20, 30) from being blocked by the front-side openings 22 even when the electron beams 8 enter the shadow mask 201 at increased angles θ, and can pass the electron beams 8 so that the electron beams 8 strike the fluorescent screen of the cathode ray tube to form thereon beam spots in the desired size and shape, while keeping the luminance high.

Further, according to the shadow mask 201 of this embodiment, the rectangular through-hole 11 of each slot 20 situated in the outer end part of the horizontal axis 3 has extended-space parts 25 extending, in the vertical direction Y, from both the upper and lower short sides of the rectangle toward the respective adjacent bridge portions 23, 23, and the rectangular through-hole 11 of each slot 20 situated in the outer end part of the diagonal axis 5 has an extended-space part 25 extending, in the vertical direction Y, from the lower short side of the rectangle toward the bridge portion 23 present on the horizontal axis 3 side. Therefore, the shadow mask 201 can be properly applied to flat-type cathode ray tubes of wide deflection angle type, which are in great demand in recent years.

Furthermore, according to the shadow mask 201 of this embodiment, of the multiple slots 2 made in the mask body 201a, those slots 2 (20, 30) situated at least in the outer end part of the horizontal axis 3 of the mask body 201a or in the outer end part of the diagonal axis 5 of the mask body 201a have rectangular front-side openings 22 with extended parts 33, each extended part extending, in the direction in which the vertical axis 4 extends, from at least one of the two short sides of the rectangle toward the adjacent bridge portion 23 to make the front-side opening 22, in its plane view, larger, and this extended part 33 gradually broadens in the vertical direction, from the starting point 33a of extension that is situated on the vertical axis 4 side in the mask body 201a toward the end point 33b of extension that is situated on the peripheral part side in the mask body 201a. For this reason, the sidewall of the front-side opening 22 of each slot 2 recedes, and the inclination of this sidewall becomes much smaller. It is, therefore, possible to eliminate, as much as possible, the problem in the prior art that electron beams are partially blocked by the rising sidewalls at sites near the bridge portions to be defective. Consequently, there can be obtained the same actions and effects as those described above.

Furthermore, according to the shadow mask 201 of the present invention, in the extended-space part 25 made in the through-hole 11 of each slot 2 or in the extended part 33 made in the front-side opening 22 of each slot 2, when the amount of extension L₁, L₂ that is distance, in the vertical direction, between the starting point 25a, 33a of extension and the end point 25b, 33b of extension is set to at least 10 μm, the prevention of blocking of electron beams is ensured.

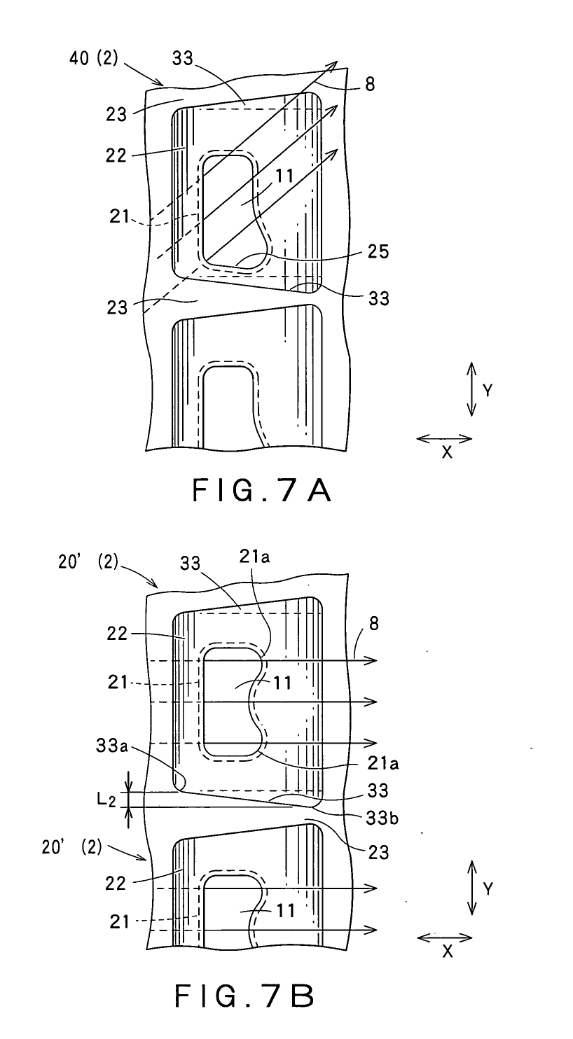

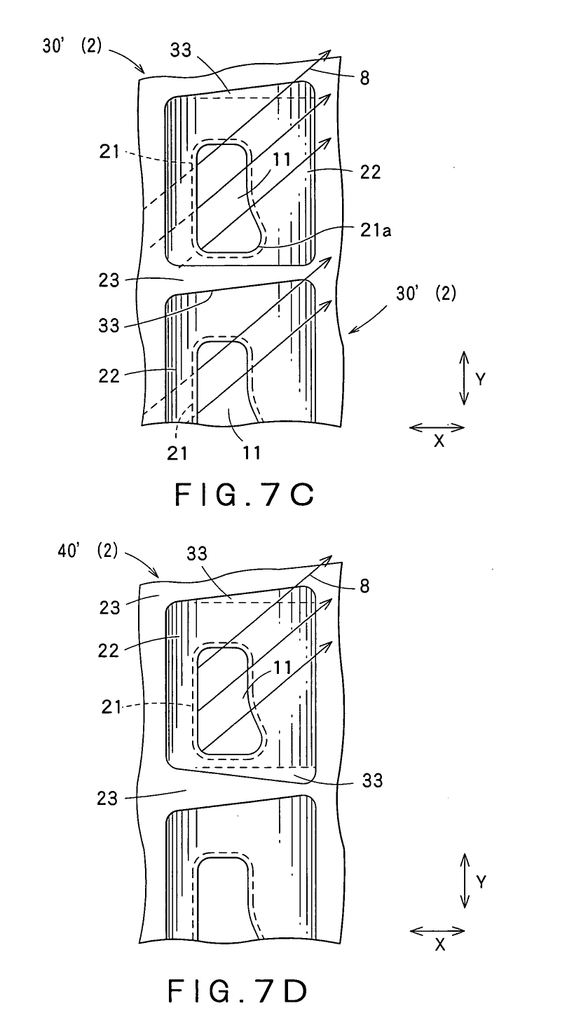

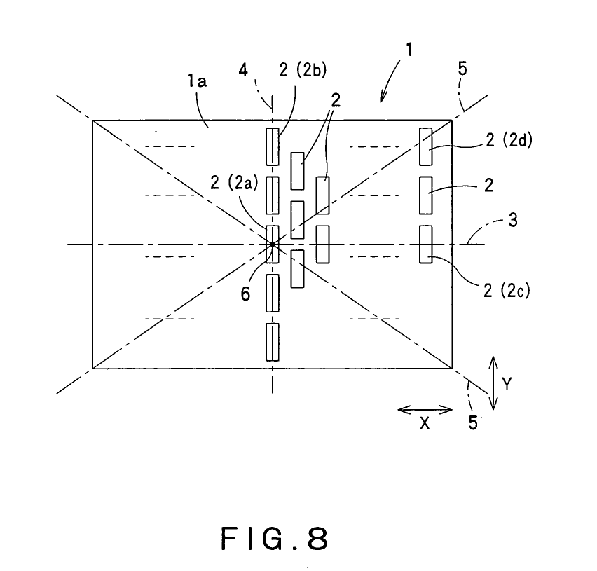

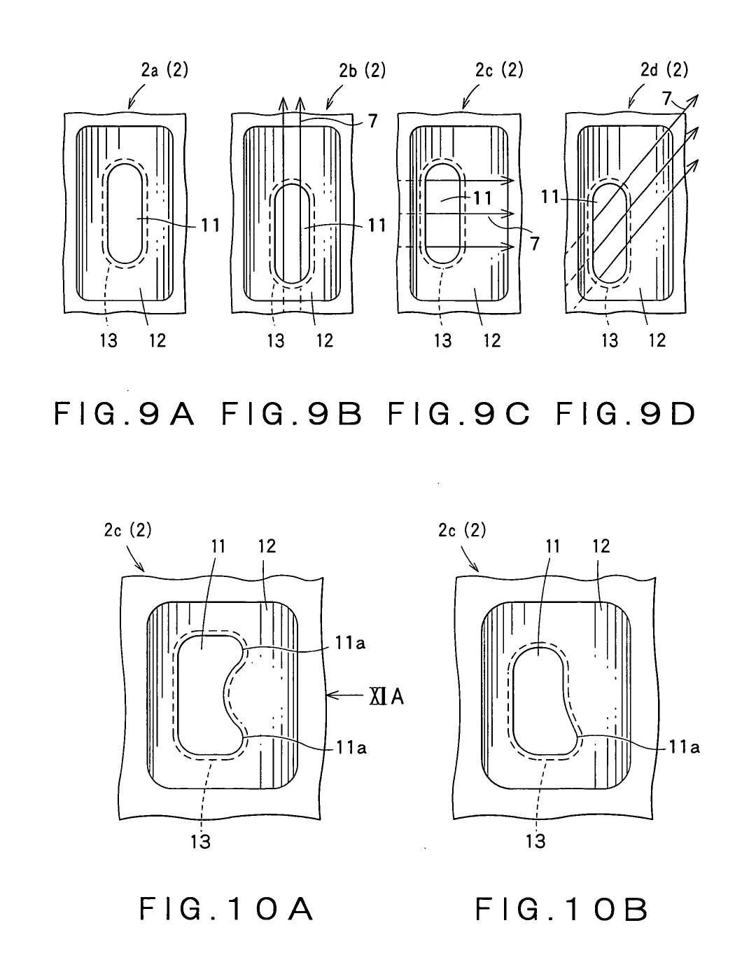

In the shadow mask 201 according to the above-described embodiment, the rectangular front-side opening 22 of each slot 30 situated in the outer end part of the diagonal axis 5 of the mask body 201a has an extended part 33 extending, in the vertical direction Y, from the upper short side of the rectangle toward the bridge portion 23, as shown in FIG. 5. Alternatively, the rectangular front-side opening 22 of each slot 30 may have extended parts 33 extended, in the vertical direction Y, from both the upper and lower short sides of the rectangle toward the respective adjacent bridge portions 23, 23, as shown in FIG. 7A.

Further, in the shadow mask 201 according to the above-described embodiment, the extended-space parts 25 extending toward the bridge portions 23 are made in the through-holes 11 of the slots 2, and the extended parts 33 extending toward the bridge portions 23 are made in the front-side openings 22. The present invention is not limited to this embodiment, and only the front-side openings 22 may have extended parts, like the slots 20′, 30′, and 40′ shown in FIGS. 7B, 7C and 7D. In this case, the extended part 33 extending in the vertical direction Y can be provided on one edge or both edges of the slot 20′, 30′, 40′. By so making the extended parts 33, the shadow mask 201 can emits electron beams 8 without blocking them even when the electron beams 8 have entered the shadow mask 201 at great angles. In this case, it is preferable that the amount of extension of the extended part 33 be at least 10 μm, as described above. The slot 20′ shown in FIG. 7B corresponds to the slot 20 shown in FIG. 1B, which is made in the right-hand outer end part of the horizontal axis 3; the slot 30′ shown in FIG. 7C corresponds to the slot 30 shown in FIG. 2, which is made in the upper-right outer end part of the diagonal axis 5 obliquely extending toward the upper right; and the slot 40′ shown in FIG. 7D corresponds to the slot 40 shown in FIG. 7A, which is made in the upper-right outer end part of the diagonal axis 5 obliquely extending toward the upper right.

(Process for Producing Shadow Mask According to the above Embodiment)

A typical process for producing the shadow mask 201 according to the above-described embodiment will be described hereinafter. It is needless to say that the shadow mask of the present invention is not limited to one produced by the following manufacturing process.

It is possible to produce the shadow mask 201 according to the aforementioned embodiment by the following conventionally known process.

Namely, to produce the shadow mask 201, a photo-etching process using a continuous in-line system is usually employed. Specifically, for example, an aqueous colloidal photoresist or the like is applied to both surfaces of a thin metal sheet and dried. Thereafter, a photomask with a pattern of the aforementioned front-side openings 22 is brought into close contact with the front surface of the metal sheet, and a photomask with a pattern of the above-described backside openings 21 is brought into close contact with the back surface of the metal sheet. This one is exposed to ultraviolet light emitted from a high mercury vapor pressure lamp or the like and then developed with water. The positional relationship between the photomask with a pattern of the front-side openings 22 and the photomask with a pattern of the backside openings 21, and the shape of these photomasks are designed with consideration for the positional relationship between the front-side openings 22 and backside openings 21 of the slots 2 to be made in the resulting shadow mask 201, and the size of the openings.

The bare-metal portions of the thin metal sheet, surrounded by the resist film, after development are made into the above-described shapes by changing the etching speed. After conducting heat treatment, etc., the etching step is effected by spraying a ferric chloride solution over both surfaces of the metal sheet, for example.

Thereafter, the post treatment including rinsing with water and stripping is successively conducted. Thus, there is finally obtained the shadow mask 201 according to the above-described embodiment.

1. A shadow mask that comprises a mask body in which a large number of slots are made in the horizontal and vertical directions and that allows electron beams to form roughly rectangular beam spots on a fluorescent screen of a cathode ray tube,
each one of the slots made in the mask body having a roughly rectangular backside opening on the side on which electron beams are incident, a roughly rectangular front-side opening on the side from which electron beams emerge, and a through-hole that connects the backside opening and the front-side opening,
the mask body having a center point situated in the center of the mask body plane, and a horizontal axis, a vertical axis, and two diagonal axes that pass through the center point and extend along the mask body plane,
the front-side opening and the backside opening of each slot in the mask body being made by an etching process,
those slots, of the multiple slots made in the mask body, that are situated at least in the outer end part of the horizontal axis of the mask body or in the outer end part of the diagonal axis of the mask body having rectangular through-holes with extended-space parts, each extended-space part extending, in the direction in which the vertical axis extends, on at least one of the two sides of the rectangle, that is, at least the side situated on the side apart from the horizontal axis or the side situated on the side near the horizontal axis, to make the through-hole, in its plane view, larger, and
the extended part of each front-side opening gradually broadening, from the starting point of extension that is situated on the vertical axis side in the mask body toward the end point of extension that is situated on the peripheral part side in the mask body.

2. The shadow mask according to claim 1, wherein each rectangular through-hole situated in the outer end part of the horizontal axis of the mask body has, as the through-hole extended-space part, a pair of extended-space parts extending, in the direction in which the vertical axis extends, on the two sides of the rectangle to make the through-hole, in its plane view, larger.

3. The shadow mask according to claim 1, wherein each rectangular through-hole situated in the outer end part of the diagonal axis of the mask body has, as the through-hole extended-space part, an extended-space part extending, in the direction in which the vertical axis extends, on the horizontal-axis-side side of the rectangle to make the through-hole, in its plane view, larger.

4. The shadow mask according to claim 1, wherein in the extended-space part of each through-hole, the amount of extension that is the distance between the starting point of extension and the end point of extension (the distance in the direction in which the vertical axis extends) is at least 10 am.

5. The shadow mask according to claim 1, wherein the degree to which the extended-space part of the through-hole of each one of the multiple slots made in the mask body is broadened is made higher either continuously or step-wise as the position of the slot gets apart from the center to the peripheral part of the mask body.

6. The shadow mask according to claim 1, wherein the rectangular through-hole of each slot further has a protrudent part protruding from at least one of the upper and lower end parts of the long side, situated on the side apart from the vertical axis, of the rectangle toward the peripheral part side, and this protrudent part and the extended-space part are connected with each other.

7. The shadow mask according to claim 1, wherein between each two slots that are arranged adjacently to each other in the direction in which the vertical axis extends is present a bridge portion remaining after the etching step,
of the multiple slots made in the mask body, those slots situated at least in the outer end part of the horizontal axis of the mask body or in the outer end part of the diagonal axis of the mask body have rectangular front-side openings with extended parts, each extended part extending, in the direction in which the vertical axis extends, on at least one of the two sides of the rectangle toward the adjacent bridge portion to make the front-side opening, in its plane view, larger, and
the extended part of each front-side opening gradually broadening, from the starting point of extension that is situated on the vertical axis side in the mask body toward the end point of extension that is situated on the peripheral part side in the mask body.

8. The shadow mask according to claim 7, wherein each rectangular front-side opening situated in the outer end part of the horizontal axis of the mask body has, as the front-side opening extended part, a pair of extended parts extending, in the direction in which the vertical axis extends, on the two sides of the rectangle toward the respective adjacent bridge portions to make the front-side opening, in its plane view, larger.

9. The shadow mask according to claim 7, wherein each rectangular front-side opening situated in the outer end part of the diagonal axis of the mask body has, as the front-side opening extended part, an extended part extending, in the direction in which the vertical axis extends, on the side, situated on the side apart from the horizontal axis, of the rectangle toward the adjacent bridge portion to make the front-side opening, in its plane view, larger.

10. The shadow mask according to claim 7, wherein in the extended part of each front-side opening, the amount of extension that is the distance between the starting point of extension and the end point of extension (the distance in the direction in which the vertical axis extends) is at least 10 μm.

11. The shadow mask according to claim 7, wherein the degree to which the extended part of the front-side opening of each one of the multiple slots made in the mask body is broadened is made higher either continuously or step-wise as the position of the slot gets apart from the center to the peripheral part of the mask body.

12. A shadow mask that comprises a mask body in which a large number of slots are made in the horizontal and vertical directions and that allows electron beams to form roughly rectangular beam spots on a fluorescent screen of a cathode ray tube,
each one of the slots made in the mask body having a roughly rectangular backside opening on the side on which electron beams are incident, a roughly rectangular front-side opening on the side from which electron beams emerge, and a through-hole that connects the backside opening and the front-side opening with each other,
the mask body having a center point situated in the center of the mask body plane, and a horizontal axis, a vertical axis, and two diagonal axes that pass through the center point and extend along the mask body plane,
the front-side opening and the backside opening of each slot in the mask body being made by an etching process, and between each two adjacent slots arranged in the direction in which the vertical axis extends being present a bridge portion remaining after the etching step,
those slots, of the multiple slots made in the mask body, that are situated at least in the outer end part of the horizontal axis of the mask body or in the outer end part of the diagonal axis of the mask body having rectangular front-side openings with extended parts, each extended part extending, in the direction in which the vertical axis extends, on at least one of the two sides of the rectangle to make the front-side opening, in its plane view, larger, and
the extended part of each front-side opening gradually broadening, from the starting point of extension situated on the vertical axis side in the mask body toward the end point of extension situated on the peripheral part side in the mask body.

13. The shadow mask according to claim 12, wherein each rectangular front-side opening situated in the outer end part of the horizontal axis of the mask body has, as the front-side opening extended part, a pair of extended parts extending, in the direction in which the vertical axis extends, on the two sides of the rectangle toward the respective adjacent bridge portions to make the front-side opening, in its plane view, larger.

14. The shadow mask according to claim 12, wherein each rectangular front-side opening situated in the outer end part of the diagonal axis of the mask body has, as the front-side opening extended part, an extended part extending, in the direction in which the vertical axis extends, on the side, situated on the side apart from the horizontal axis, of the rectangle toward the adjacent bridge portion to make the front-side opening, in its plane view, larger.

15. The shadow mask according to claim 12, wherein in the extended part of each front-side opening, the amount of extension that is the distance between the starting point of extension and the end point of extension (the distance in the direction in which the vertical axis extends) is at least 10 μm.

16. The shadow mask according to claim 12, wherein the degree to which the extended part of the front-side opening of each one of the multiple slots made in the mask body is broadened is made higher either continuously or step-wise as the position of the slot gets apart from the center to the peripheral part of the mask body.
